(19) United States
(12) Patent Application Publication
(10) Pub. No.: US 2016/0332600 A1
(43) Pub. Date: Nov. 17, 2016

(54) CONNECTION CLIP FOR CONNECTING WIPER BLADE WITH WIPER ARM AND WIPER BLADE INCLUDING THE SAME

(71) Applicant: KCW Corporation, Daegu (KR)

(72) Inventors: Young Dong Kang, Daegu (KR); Seong Hun Nam, Daegu (KR); Ji Yeong Bae, Daegu (KR); Keun Woo Kim, Daegu (KR); Young Geun Jang, Daegu (KR); Jeong Nam Jeong, Daegu (KR)

(21) Appl. No.: 15/152,788

(22) Filed: May 12, 2016

(30) Foreign Application Priority Data
May 13, 2015 (KR) 1020150066688
May 13, 2015 (KR) 1020150066690

(51) Int. Cl. B60S 1/40

(52) U.S. Cl. CPC B60S 1/40; B60S 2001/4093

(57) ABSTRACT

A wiper blade includes: a wiper strip which wipes a window glass of a vehicle; a lever assembly which supports the wiper strip; and a cover which is coupled to a wiper arm and receives the lever assembly. The cover includes a connection clip which is made of a resin material and is coupled to the cover by using an insert injection process. The connection clip includes a connection shaft and a pair of supports which are formed on both ends of the connection shaft and face each other. The support includes a wide width portion and a narrow width portion in a cross section of the support, which is perpendicular to a longitudinal direction of the wiper blade. A width of the narrow width portion in a width direction of the wiper blade is less than a width of the wide width portion in the width direction.

### CROSS REFERENCE TO RELATED APPLICATIONS

Priority is claimed to is claimed under 35 U.S.C. §119 to Korean Patent Application No. 10-2015-0066688, filed May 13, 2015, and to Korean Patent Application No. 10-2015-0066690, filed May 13, 2015. The disclosures of the aforementioned priority applications are incorporated herein by reference in their entirety.

### FIELD OF THE INVENTION

The present disclosure relates to a connection clip for connecting a wiper blade with a wiper arm, and a wiper blade including the same.

### BACKGROUND OF THE INVENTION

In general, a wiper blade removes impurities, snow, rain or the like when driving and prevents a driver's front sight from being deteriorated. As a motor drives a link apparatus connected to a wiper arm, the wiper blade performs repetitive reciprocating rotation in a fan shape.

In the reciprocating rotation of the wiper blade, both ends of the wiper blade have different travel distances for the same period of time. Specifically, as shown in FIG. 1, while one end further from the rotational axis of a wiper blade 1 moves a distance of “a”, the other end closer to the rotational axis of the wiper blade 1 moves a distance of “b”. Here, angular velocities of the both ends of the wiper blade 1 are difficult to be maintained the same in accordance with a force at which the both ends of the wiper blade 1 press the glass of the vehicle, the state of the glass surface, the state of a wiper strip, temperature, rainfall, etc. Therefore, as shown in FIGS. 2 and 3, when the wiper blade 1 performs the reciprocating rotation, torsion occurs in the width direction of the wiper blade 1. Also, in the handling of the wiper blade 1, for example, when a worker, who produces, assembles, repairs, or replaces the wiper blade 1, holds a wiper arm 2 and the wiper blade 1 by his/her hand at the same time, or when an load is added to the wiper arm 2 and the wiper blade 1 at the time of delivering and storing the wiper blade 1, the torsion may also occur in the width direction of the wiper blade 1. In the use of the wiper blade 1, for example, when a user restricts the wiper blade 1 by his/her hand at the time of operating the wiper blade 1, when the reciprocating rotation of the wiper blade 1 is partially restricted due to snowfall or other foreign substances, or when the wiper blade 1 is caught by washing tools at the time of washing the vehicle, the torsion may also occur in the width direction of the wiper blade 1. In this case, stress is concentrated on a narrow area 5 where a side wall 4 of the wiper blade 1 is connected to a connection shaft 3 of the wiper blade 1, to which the wiper arm 2 is connected, so that the connection portion between the connection shaft of the wiper blade 1 and the side wall 4 of the wiper blade 1 is easily damaged.

In the past, in order to solve the above problems, a method in which the metallic connection shaft is insert-molded into a cover of the wiper blade has been provided. In this case, however, a contact area the resin material-made cover of the wiper blade and the metallic connection shaft is small, and thus, a coupling force is reduced. Also, due to the difference in the coefficient of thermal expansion between the resin material-made cover and the metallic connection shaft, the external appearance thereof becomes poor after the insert-molding. Likewise, due to the difference in the coefficient of thermal expansion between the resin material-made cover and the metallic connection shaft, the dimension of the inner surface of the cover into which the wiper arm is inserted is difficult to be managed by intervals. Also, the metallic connection shaft becomes rusty or a separate oil removal process is additionally required in order to increase the coupling force between the connection shaft and the cover. Further, there has been provided a method for injecting the cover of the wiper blade, with which the thick connection shaft has been integrally formed. However, when a synthetic resin material made of a single material is injected, the thickness of the side wall of the cover of the portion where the connection shaft is located is larger than that of the side wall of the cover of the portion where the connection shaft is not located. Therefore, as the injected cover is cooled, the side wall of the cover of the portion where the connection shaft is located contracts more than the side wall of the cover of the portion where the connection shaft is not located. As a result, when the side wall of the cover is viewed from the outside after being cooled, the side wall of the cover of the portion where the connection shaft is located is recessed more than the side wall of the cover of the portion where the connection shaft is not located, and thus, the external appearance becomes poor. Also, when the rigidity is obtained by thickening the connection shaft in this manner, the compatibility with the wiper arms to be connected is reduced.

Also, in the process of molding the cover, the cover is molded in a state where the connection shaft is not arranged at a correct position, so that the external appearance becomes poor or the coupling force between the connection shaft and the cover is reduced. As a result, the connection portion between the connection shaft of the wiper blade and the cover of the wiper blade is easily damaged.

Also, in the process of molding the cover, the molten resin material which is inserted into a mold does not flow smoothly, so that bubbles are formed in the connection portion between the cover and the connection shaft, or the cover is molded in a state where an injection molded product of the connection portion between the cover and the connection shaft has a low density. Therefore, the external appearance becomes poor or the coupling force between the connection shaft and the cover is reduced. As a result, the connection portion between the connection shaft of the wiper blade and the cover of the wiper blade is easily damaged.

### SUMMARY OF THE INVENTION

One embodiment is a wiper blade that includes: a wiper strip which wipes a window glass of a vehicle; a lever assembly which supports the wiper strip; and a cover which is coupled to a wiper arm and receives the lever assembly. The cover may include a connection clip which is made of a resin material and is coupled to the cover by using an insert injection process. The connection clip may include a connection shaft and a pair of supports which are formed on both ends of the connection shaft and face each other. The support may include a wide width portion and a narrow width portion in a cross section of the support, which is perpendicular to a longitudinal direction of the wiper blade. A width of the narrow width portion in a width direction of the wiper blade may be less than a width of the wide width portion in the width direction of the wiper blade.

Another embodiment is a wiper blade that includes: a wiper strip which wipes a window glass of a vehicle; a lever assembly which supports the wiper strip; and a cover which is coupled to a wiper arm and receives the lever assembly. The cover may include a connection clip which is made of a resin material and is coupled to the cover by using an insert injection process. The connection clip may include a connection shaft and a pair of supports which are formed on both ends of the connection shaft and face each other. The support may include a wide width portion and a narrow width portion in a cross section of the support, which is perpendicular to a width direction of the wiper blade. A width of the narrow width portion in a height direction of the wiper blade may be less than a width of the wide width portion in the height direction of the wiper blade.

Further another embodiment is a wiper blade that includes: a wiper strip which wipes a window glass of a vehicle; a lever assembly which supports the wiper strip; and a cover which is coupled to a wiper arm and receives the lever assembly. The cover may include a connection clip which is made of a resin material and is coupled to the cover by using an insert injection process. The connection clip may include a connection shaft and a pair of supports which are formed on both ends of the connection shaft and face each other. The support may include a tapered portion formed on the outside of the support in a longitudinal direction of the wiper blade.

### BRIEF DESCRIPTION OF THE DRAWINGS

FIG. 1 is a view for describing a reciprocating rotation of a wiper blade;

FIG. 2 is a view for describing that torsion occurs in the width direction of the wiper blade;

FIG. 3 is a view showing a connection portion between a wiper arm and the wiper blade when torsion occurs in the width direction of the wiper blade;

FIG. 4 is a perspective view showing the wiper arm and the wiper blade including a connection clip according to the embodiment of the present invention;

FIG. 5 is a perspective view showing a connection clip according to a first embodiment of the present invention;

FIG. 6 is a plan view showing that the connection clip has been coupled to a cover in accordance with the embodiment of the present invention;

FIGS. 7a and 7b are cross sectional views of the connection clip and the cover according to the first embodiment shown in FIG. 6, which are taken along line A-A′ and are perpendicular to the longitudinal direction of the wiper blade;

FIG. 7c is a cross sectional view of the connection clip and the cover according to the first embodiment shown in FIG. 6, which is taken along line C-C′ and is perpendicular to the longitudinal direction of the wiper blade;

FIG. 8 is a perspective view showing a connection clip according to a second embodiment of the present invention;

FIGS. 9a to 9h are cross sectional views of the connection clip according to the second embodiment of the present invention, which are taken along line B-B′ and are perpendicular to the longitudinal direction of the wiper blade;

FIGS. 10a and 10b are cross sectional views of the connection clip and a cover according to the second embodiment shown in FIG. 6, which are taken along line C-C′ and are perpendicular to the longitudinal direction of the wiper blade;

FIGS. 11 to 13 are perspective views showing another embodiments of the connection clip according to the second embodiment of the present invention;

FIGS. 14a to 14e are cross sectional views of the connection clip according to the second embodiment of the present invention, which are taken along line A-A′ and are perpendicular to the width direction of the wiper blade;

FIGS. 15a and 15b are cross sectional views of the connection clip and the cover according to the present invention shown in FIG. 6, which are taken along line B-B′ and are perpendicular to the width direction of the wiper blade;

FIGS. 16 to 18 are perspective views showing further another embodiments of the connection clip according to the second embodiment of the present invention;

FIG. 19 is a perspective view showing a connection clip according to a third embodiment of the present invention;

FIGS. 20a and 20d are cross sectional views of the connection clip according to the third embodiment of the present invention, which are taken along line A-A′ and are perpendicular to the height direction of the wiper blade;

FIGS. 21a to 21d are views showing the flow of a resin material when the molten resin material is inserted into a mold in a state where a support of the connection clip according to the embodiment of the present invention is disposed within the mold for manufacturing the cover;

FIGS. 22 to 28 are perspective views showing another embodiment of the connection clip according to the third embodiment of the present invention; and

FIGS. 29a to 29c are cross sectional views of the connection clip according to the third embodiment of the present invention, which are taken along line B-B′ and are perpendicular to the longitudinal direction of the wiper blade.

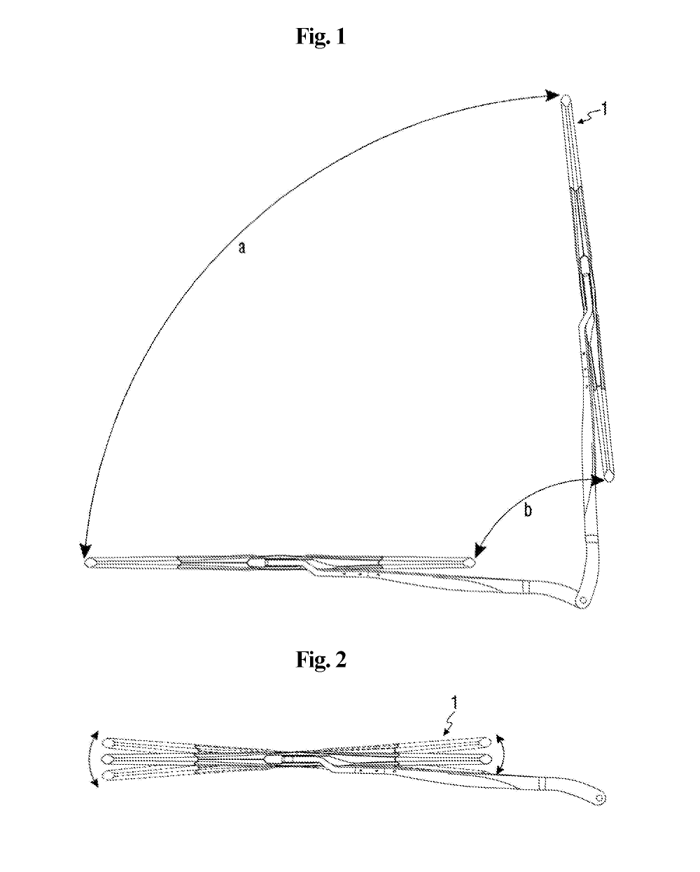

### DETAILED DESCRIPTION OF THE INVENTION

An embodiment of the present invention will be described in detail with reference to the accompanying drawings. In the components of the present invention, detailed descriptions of what can be clearly understood and easily carried into practice through a prior art by those skilled in the art will be omitted to avoid making the subject matter of the present invention unclear.

Hereinafter, a connection clip and a wiper blade including the connection clip according to an embodiment of the present invention will be described.

FIG. 4 is a perspective view showing a wiper arm and the wiper blade including the connection clip according to the embodiment of the present invention.

Referring to FIG. 4, the wiper blade 1 according to the embodiment of the present invention includes a wiper strip (not shown) which wipes the window glass of a vehicle, a lever assembly (not shown) which supports the wiper strip, a cover 10 which receives the lever assembly, and a connector 20.

The wiper strip (not shown) directly contacts the window glass of the vehicle and removes impurities of the surface of the window glass. The wiper strip is made of an elastic material such as a rubber material, or is made of an elastic composite material.

The lever assembly (not shown) supports directly the wiper strip. The lever assembly (not shown) may include one or two pairs of yoke levers. A yoke-shaped end of the yoke lever may support the wiper strip.

The cover 10 receives the lever assembly (not shown) and is coupled to the wiper arm 2. The wiper arm 2 transmits a pressing force to the cover 10 through the connector 20. The cover 10 transmits the pressing force applied from the wiper arm 2 to the lever assembly (not shown). Then, the lever assembly (not shown) transmits the pressing force to the wiper strip.

The cover 10 may include a pair of mutually facing side walls 11, a recess 12 which is approximately formed in the center of the cover 10 and is formed between the pair of side walls 11, and a connection clip 100 for the coupling to the wiper arm 2.

### First Embodiment

Hereinafter, first, the connection clip according to a first embodiment will be described.

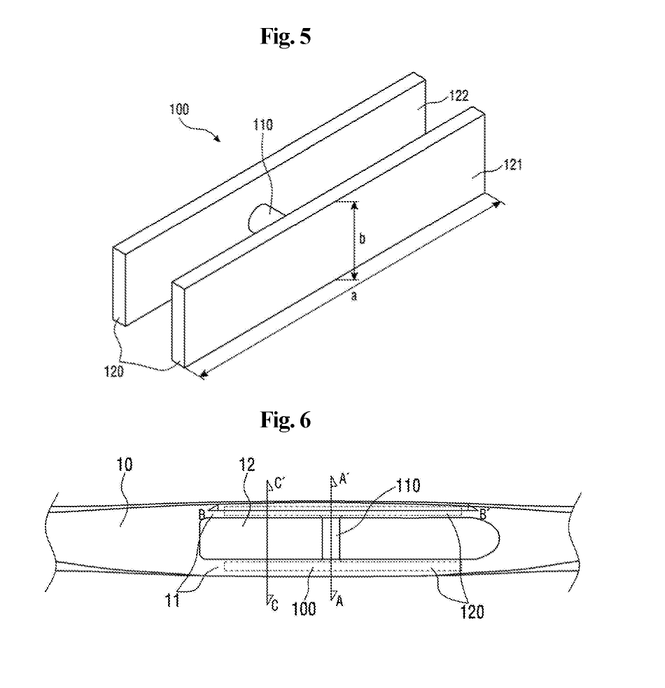

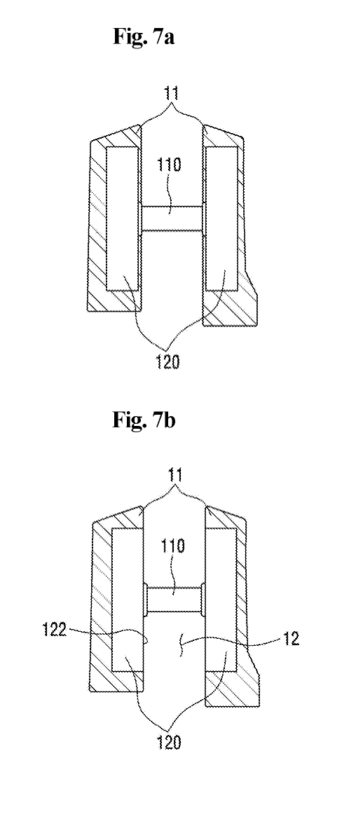

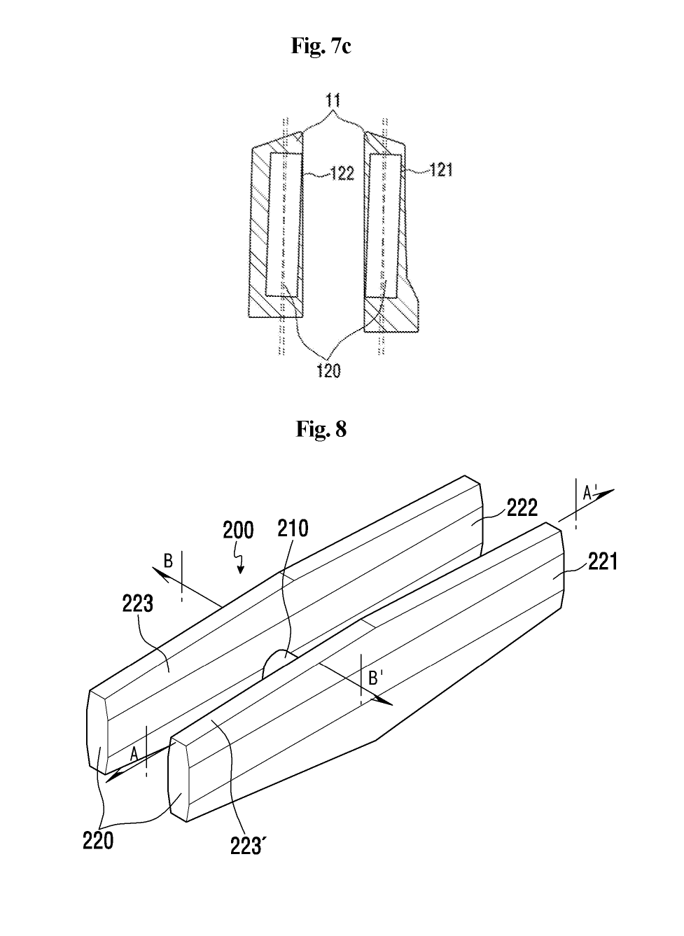

FIG. 5 is a perspective view showing the connection clip according to the first embodiment of the present invention. FIG. 6 is a plan view showing that the connection clip has been coupled to the cover in accordance with the embodiment of the present invention. FIGS. 7a and 7b are cross sectional views of the connection clip and the cover according to the first embodiment shown in FIG. 6, which are taken along line A-A′ and are perpendicular to the longitudinal direction of the wiper blade.

Referring to FIG. 5, the connection clip 100 may include a connection shaft 110 and a pair of supports 120 which are formed on both ends of the connection shaft 110 and face each other. Here, the connection clip 100 is coupled to the cover 10. Referring to FIG. 6, each of the supports 120 may be coupled to the pair of side walls 11 of the cover 10 respectively such that the connection shaft 110 of the connection clip 100 is located in the recess 12 of the cover 10.

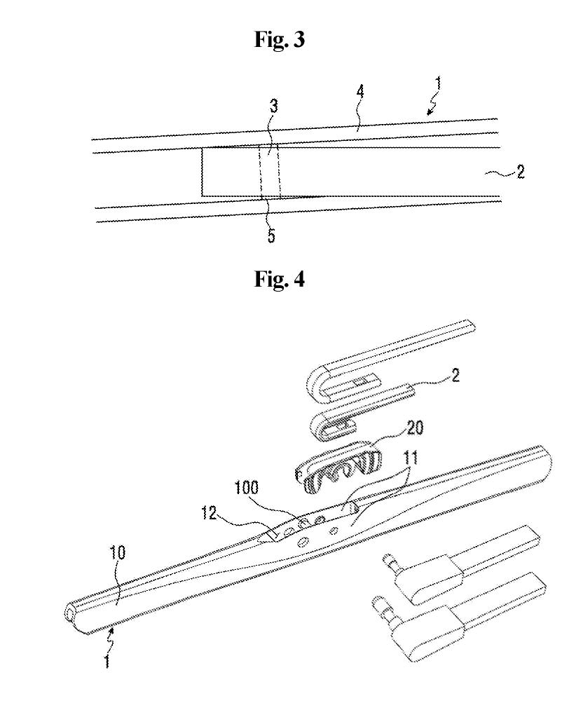

Here, the connection clip 100 is coupled to the cover 10 by using an insert injection process. Specifically, first, the connection clip 100 is manufactured by using an injection process. Here, the connection clip 100 may be made of a resin material having a higher flexural rigidity than that of the material of the cover 10. Likewise, since the connection clip 100 having a higher flexural rigidity than that of the cover 10 is used, even when torsion, as shown in FIG. 3, occurs in the width direction of the wiper blade 1 and thus the stress is concentrated on the connection clip 100, so that the connection clip 100 is not easily damaged. Then, in a state where the previously produced connection clip 100 is disposed within a mold for manufacturing the cover 10, the connection clip 100 is coupled to the cover 10 through the insert injection process in which when the molten resin material, i.e., the material of the cover 10, is inserted into the mold. Here, since both the connection clip 100 and the cover 10 are made of the resin material, melt-bonding occurs between the connection clip 100 and an injection molded product during the insert injection. As a result, compared with the form of insert-molding of the metallic connection shaft, a coupling force between the connection clip 100 and the cover 10 increases.

As shown in FIGS. 5 and 6, the support 120 of the connection clip 100 may have a long rectangular shape in the longitudinal direction of the wiper blade 1 in such a manner as to fit the shape of the side wall 11 forming the recess 12 of the cover 10. Specifically, the length “a” of the support 120 of the connection clip 100 in the longitudinal direction of the wiper blade may be greater than the height “b” of the support 120 in the height direction of the wiper blade. Therefore, the stress generated in the connection shaft 110 is distributed to a wide contact area between the support 120 and the side wall 11 of the cover 10, so that it is possible to effectively prevent the connection clip 100 from being damaged.

Referring to FIG. 7, the connection clip 100 and the cover 10 may be coupled to each other in the form that the supports 120 of the connection clip 100 are fully inserted into the pair of side walls 11 respectively. When the supports 120 of the connection clip 100 are fully inserted into the pair of side walls 11 respectively, the contact area between the support 120 and the side wall 11 is increased. As a result, the coupling force between the connection clip 100 and the cover 10 is increased.

Also, as shown in FIG. 7b, the connection clip 100 and the cover 10 may be coupled to each other in the form that the support 120 is inserted into the side wall 11 such that at least a portion of an inner surface 122 of the support 120 of the connection clip 100 is exposed to the recess 12 formed in the cover 10. Through the coupling of the wiper arm 2 and the wiper blade 1, an end of the wiper arm 2 is located within the recess 12, so that it is necessary to precisely manage the distance between the side walls 11 of the cover 10 by intervals. Therefore, as described above, when the connection clip 100 and the cover 10 are coupled to each other in the form that the support 120 is inserted into the side wall 11 such that the inner surface 122 of the support 120 is exposed to the recess 12 formed in the cover 10, the cover 10 is formed in the insert injection process in a state where the inner surfaces of the supports 120 of the connection clip 100, which have the already precisely managed distance between the inner surfaces of the pair of supports 120, contact the mold for manufacturing the cover 10. Therefore, the distance between the side walls 11 of the cover 10 is easily managed by intervals.

### Second Embodiment

Hereinafter, a connection clip according to a second embodiment will be described.

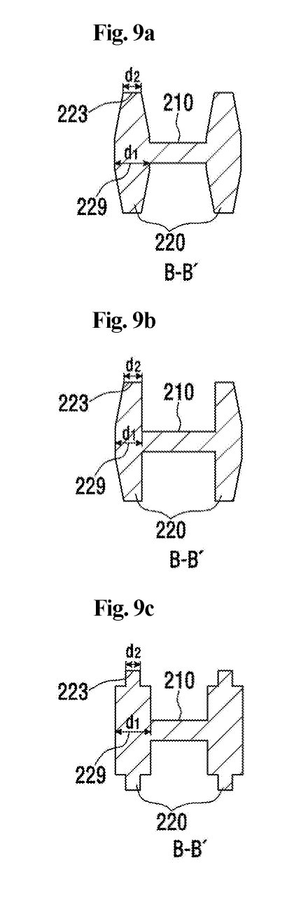

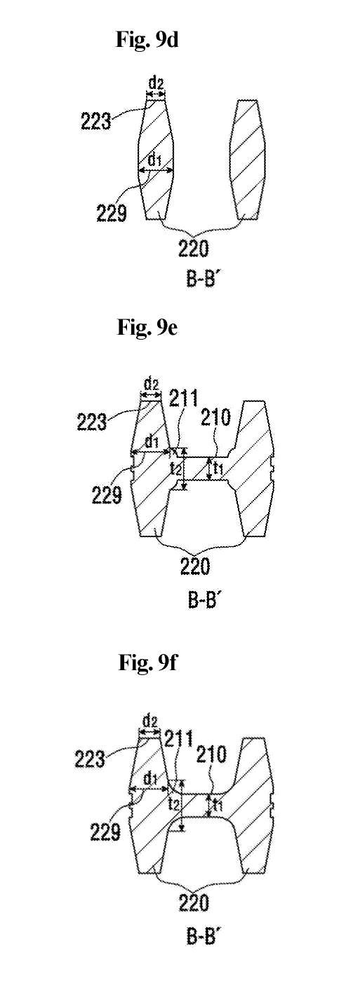

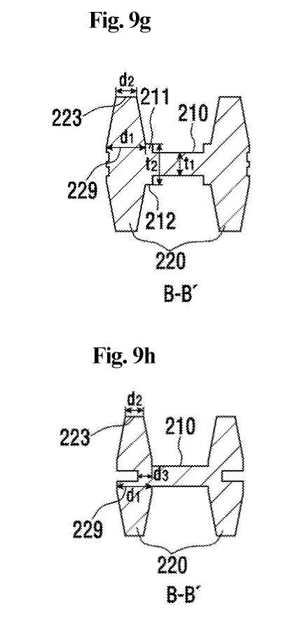

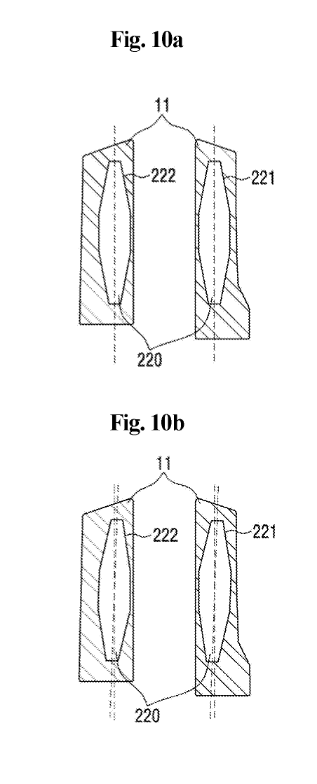

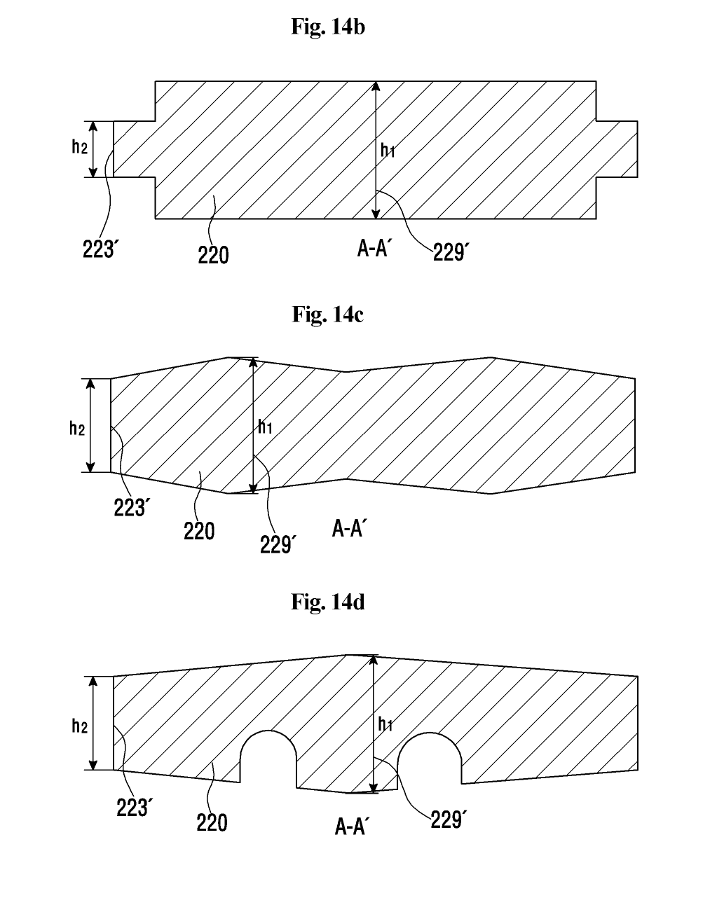

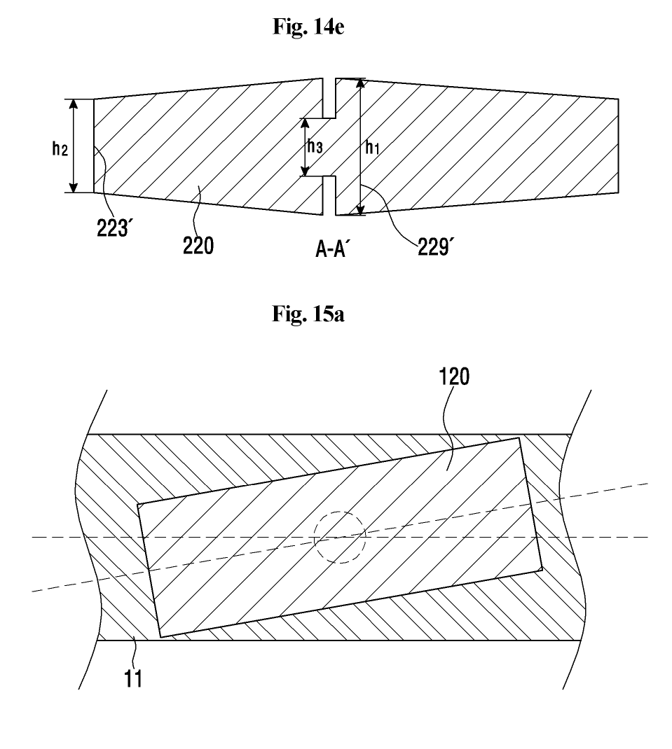

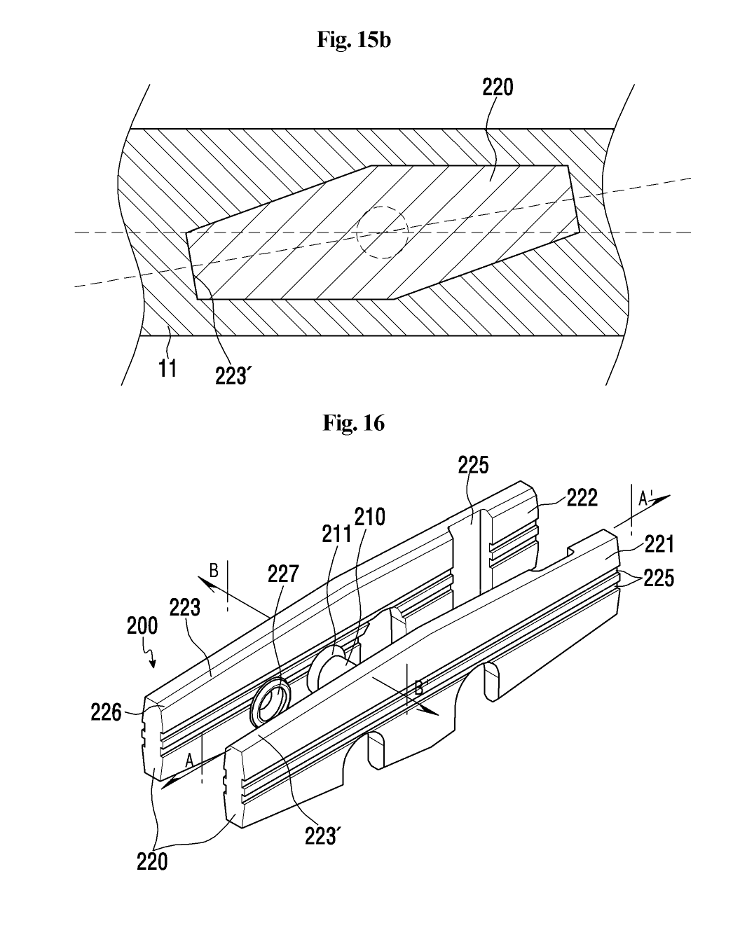

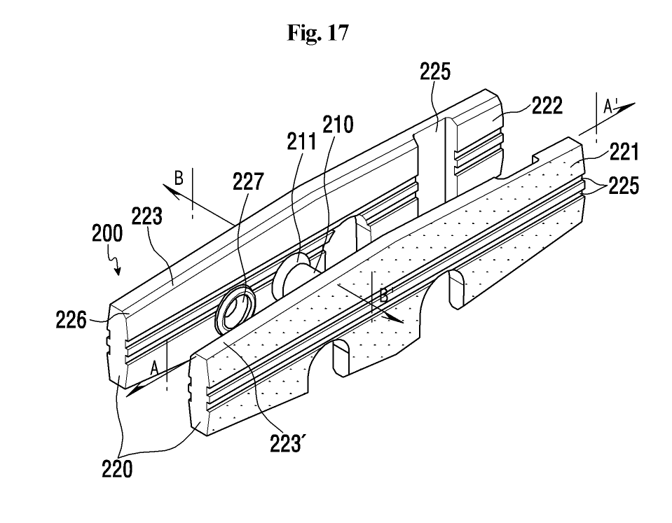

FIGS. 8, 11 to 13, and 16 to 18 are perspective view showing the connection clip according to the second embodiment of the present invention. FIGS. 9a to 9h are cross sectional views of the connection clip according to the second embodiment of the present invention, which are taken along line B-B′ and are perpendicular to the longitudinal direction of the wiper blade. FIGS. 10a and 10b are cross sectional views of the connection clip and a cover according to the second embodiment shown in FIG. 6, which are taken along line C-C′ and are perpendicular to the longitudinal direction of the wiper blade. FIGS. 14a to 14b are cross sectional views of the connection clip according to the second embodiment of the present invention, which are taken along line A-A′ and are perpendicular to the width direction of the wiper blade. FIGS. 15a and 15b are cross sectional views of the connection clip and the cover according to the present invention shown in FIG. 6, which are taken along line B-B′ and are perpendicular to the width direction of the wiper blade.

As with the connection clip 100 according to the first embodiment, a connection clip 200 according to the second embodiment may be made of a resin material and may be coupled to the cover 10 through the insert injection process. Hereinafter, the following description will focus on differences from the first embodiment.

The connection clip 200 may include a connection shaft 210 and a pair of supports 220 which are formed on both ends of the connection shaft 210 and face each other.

Referring to FIGS. 8, 11 to 13, and 16 to 18, the support 220 may include a narrow width portion 223 having a width narrower than those of other portions in a cross section of the support 220, which is perpendicular to the longitudinal direction of the wiper blade 1.

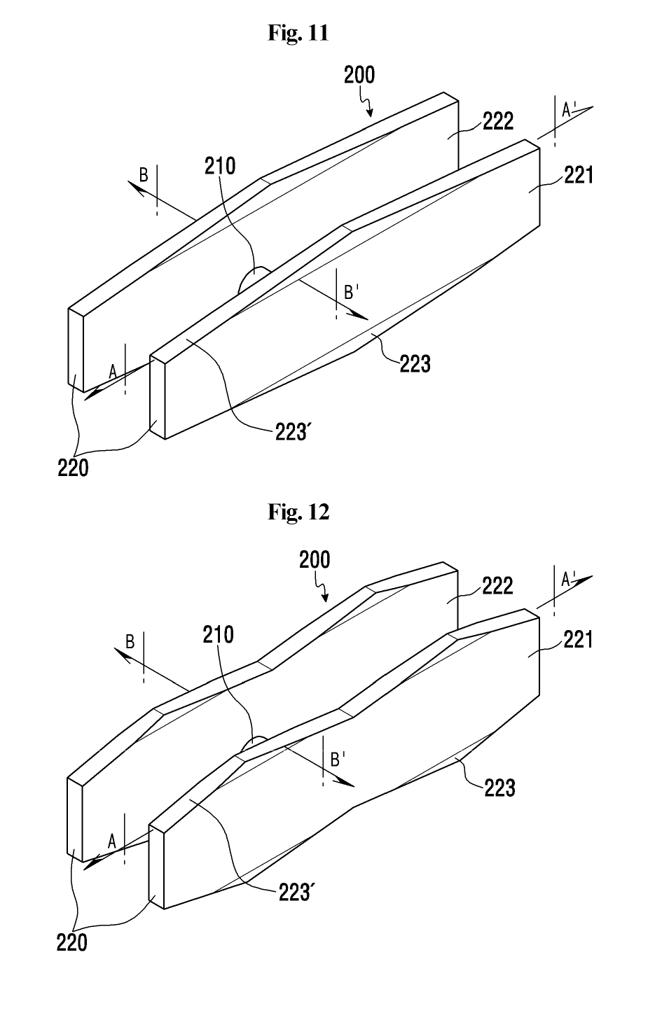

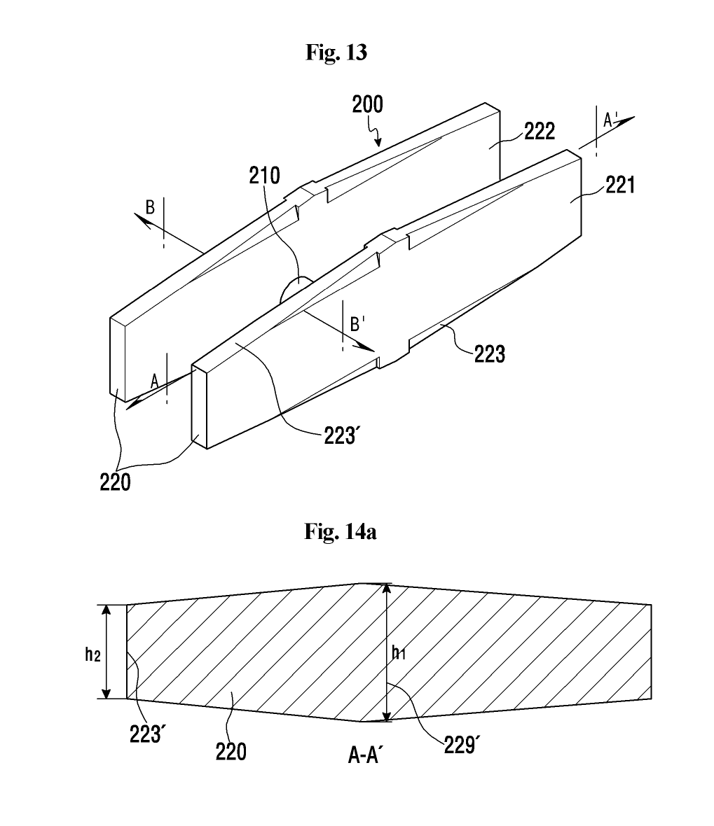

Specifically, referring to FIG. 8, the narrow width portion 223 may be entirely formed on the upper portion or lower portion of the support 220. Also, referring to Fig. 11, the narrow width portion 223 may be formed only on a portion of the upper portion or lower portion of the support 220. Also, as shown in FIGS. 12 and 13, the narrow width portion 223 may not be formed at a position where the connection shaft 210 is disposed.

FIG. 9a is a cross sectional view showing the connection clip shown in FIGS. 8 and 11 according to the second embodiment of the present invention, which is taken along line B-B′ and is perpendicular to the longitudinal direction of the wiper blade. FIG. 9d is a cross sectional view showing the connection clip shown in FIGS. 12 and 13 according to the second embodiment of the present invention, which is taken along line B-B′ and is perpendicular to the longitudinal direction of the wiper blade. FIG. 9e is a cross sectional view showing the connection clip shown in FIGS. 16 to 18 according to the second embodiment of the present invention, which is taken along line B-B′ and is perpendicular to the longitudinal direction of the wiper blade.

As shown in FIGS. 9a to 9h, a width “d2” of the narrow width portion 223 may be less than a width “d1” of a wide width portion 229, i.e., the thickest portion in the cross section of the support 220, which is perpendicular to the longitudinal direction of the wiper blade 1.

Specifically, as shown in FIG. 9a, both the inner surface and the outer surface of the narrow width portion 223 may have an inclined surface, or as shown in FIG. 9b, only the outer surface may have an inclined surface. As such, due to the fact that the inner surface or outer surface of the narrow width portion 223 has an inclined surface, the width of the narrow width portion 223 may become smaller the farther it is from the connection shaft 210 in the height direction of the wiper blade 1. Also, as shown in FIG. 9c, the narrow width portion 223 may not have an inclined surface. Also, the width “d2” of the narrow width portion 223 may not necessarily be less than the widths of all other portions other than the narrow width portion 223 in the cross section of the support 220, which is perpendicular to the longitudinal direction of the wiper blade 1. Specifically, as shown in FIG. 9h, the width “d2” of the narrow width portion 223 may be greater than a width “d3” of a portion in the cross section of the support 220, which is perpendicular to the longitudinal direction of the wiper blade 1, and may be less than the width “d1” of the thickest portion, i.e., the wide width portion 229.

As shown in FIG. 10a, in the insert injection process, if the support 220 of the connection clip 200 is coupled to the side wall 11 of the cover 10 in an approximately parallel state, the connection clip 200 may be coupled in a state of stably being disposed within the side wall 11 of the cover 10. However, during the disposition of the connection clip 200 within the mold for manufacturing the cover 10, the connection shaft 210 of the connection clip 200 is fixed by a fixing device. On the contrary to this, the support 220 of the connection clip 200 may not be arranged at a correct position. Also, when the molten resin material, i.e., the material of the cover 10 is inserted into the mold, the resin material is inserted at a high pressure and the connection clip 200 is made of a flexible resin material. Therefore, unlike the connection shaft 210 of the connection clip 200 which is fixed by the fixing device, the support 220 of the connection clip 200 may be modified by the insertion pressure. As a result, the connection clip 200 and the cover 10 may be coupled in the state where the support 220 of the connection clip 200 has been modified.

FIGS. 7c and 10b are cross sectional views of the connection clip and the cover according to the embodiment shown in FIG. 6, which are taken along line C-C′ and are perpendicular to the longitudinal direction of the wiper blade, in a state where the support of the connection clip according to the embodiment of the present invention has been coupled to the cover with an error that has occurred in the width direction of the wiper blade.

Here, regarding the connection clip 100 according to the first embodiment, the upper portion or the lower portion of the support 120 of the connection clip 100 according to the first embodiment is, as shown in FIG. 7c, is coupled in a state very close to an outer surface or an inner surface of the side wall 11 of the cover 10. Therefore, the connection clip 100 may project outside or inside the side wall 11 of the cover 10, or a very small distance is generated between the outer surface or inner surface of the side wall 11 of the cover 10 and the outer surface 121 or inner surface 122 of the support 120 of the connection clip 100 disposed within the side wall 11 of the cover 10. As a result, the external appearance of the cover 10 becomes poor and the coupling force between the connection clip 100 and the cover 10 is reduced.

On the contrary to this, regarding the connection clip 200 according to the second embodiment, even when the support 220 of the connection clip 200 is coupled to the cover 10 with an error that has occurred in the width direction of the wiper blade 1, the narrow width portion 223 prevents, as shown in FIG. 10b, the connection clip 200 from projecting outside or inside the side wall 11 of the cover 10, or prevents a distance between the outer surface or inner surface of the side wall 11 of the cover 10 and an outer surface 221 or inner surface 222 of the support 220 of the connection clip 200 disposed within the side wall 11 of the cover 10 from being less than a predetermined distance. Therefore, the connection clip 200 and the cover 10 can be stably coupled to each other.

Referring to FIGS. 8, 11 to 13 and 16 to 18, the support 120 may include the support 220 may include a narrow width portion 223′ having a less thickness in the height direction of the wiper blade 1 than those of other portions in the cross section of the support 220, which is perpendicular to the width direction of the wiper blade 1.

FIG. 14a is a cross sectional view of the connection clip shown in FIGS. 8, 11 and 13 according to the second embodiment of the present invention, which is taken along line A-A′ and is perpendicular to the width direction of the wiper blade. FIG. 14c is a cross sectional view of the connection clip shown in FIG. 12 according to the second embodiment of the present invention, which is taken along line A-A′ and is perpendicular to the width direction of the wiper blade. FIG. 14d is a cross sectional view of the connection clip shown in FIGS. 16 to 18 according to the second embodiment of the present invention, which is taken along line A-A′ and is perpendicular to the width direction of the wiper blade.

As shown in FIGS. 14a to 14e, a thickness “h2” of the narrow width portion 223′ in the height direction of the wiper blade may be less than a thickness “h1” of a wide width portion 229′ in the height direction of the wiper blade 1. The wide width portion 229′ corresponds to the thickest portion in the cross section of the support 220, which is perpendicular to the width direction of the wiper blade 1.

Specifically, as shown in FIG. 14a, both the top surface and the bottom surface of the narrow width portion 223′ may have an inclined surface. As such, due to the fact that the top surface or the bottom surface of the narrow width portion 223′ has an inclined surface, the thickness of the narrow width portion 223′ in the height direction of the wiper blade may become smaller the farther it is from the connection shaft 210 in the longitudinal direction of the wiper blade 1. Also, as shown in FIG. 14b, the narrow width portion 223′ may not have an inclined surface. Also, the thickness “h2” of the narrow width portion 223′ in the height direction of the wiper blade may not necessarily be less than the thicknesses of all other portions other than the narrow width portion 223′ in the height direction of the wiper blade in the cross section of the support 220, which is perpendicular to the width direction of the wiper blade 1. Specifically, as shown in FIG. 14e, the thickness “h2” of the narrow width portion 223′ in the height direction of the wiper blade may be greater than a thickness “h3” in the height direction of the wiper blade of a portion in the cross section of the support 220, which is perpendicular to the width direction of the wiper blade 1, and may be less than the thickness “h1” of the wide width portion 229′, i.e., the thickest portion, in the height direction of the wiper blade 1.

As described above, in the insert injection process, the connection clip may be coupled to the cover in a state where the support 220 of the connection clip 200 is not arranged at a correct position.

FIGS. 15a and 15b are cross sectional views of the connection clip and the cover according to the present invention shown in FIG. 6, which are taken along line B-B′ and are perpendicular to the width direction of the wiper blade, in a state where the support of the connection clip according to the embodiment of the present invention has been coupled to the cover with an error that has occurred in the height direction of the wiper blade.

Here, regarding the connection clip 100 according to the first embodiment, the right end or left end of the support 120 of the connection clip 100 according to the first embodiment is, as shown in FIG. 15a, is coupled in a state very close to the top surface or the bottom surface of the side wall 11 of the cover 10. Therefore, the connection clip 100 may project upward or downward from the side wall 11 of the cover 10, or a very small distance is generated between the top surface or the bottom surface of the side wall 11 of the cover 10 and the top surface or the bottom surface of the support 120 of the connection clip 100 disposed within the side wall 11 of the cover 10. As a result, the external appearance of the cover 10 becomes poor and the coupling force between the connection clip 100 and the cover 10 is reduced.

On the contrary to this, regarding the connection clip 200 according to the second embodiment, even when the support 220 of the connection clip 200 is coupled to the cover with an error that has occurred in the height direction of the wiper blade 1, the narrow width portion 223′ prevents, as shown in FIG. 15b, the connection clip 200 from projecting upward or downward from the side wall 11 of the cover 10, or prevents a distance between the top surface or the bottom surface of the side wall 11 of the cover 10 and the top surface or the bottom surface of the support 220 of the connection clip 200 disposed within the side wall 11 of the cover 10 from being less than a predetermined distance. Therefore, the connection clip 200 and the cover 10 can be stably coupled to each other.

### Third Embodiment

Hereinafter, a connection clip according to a third embodiment will be described.

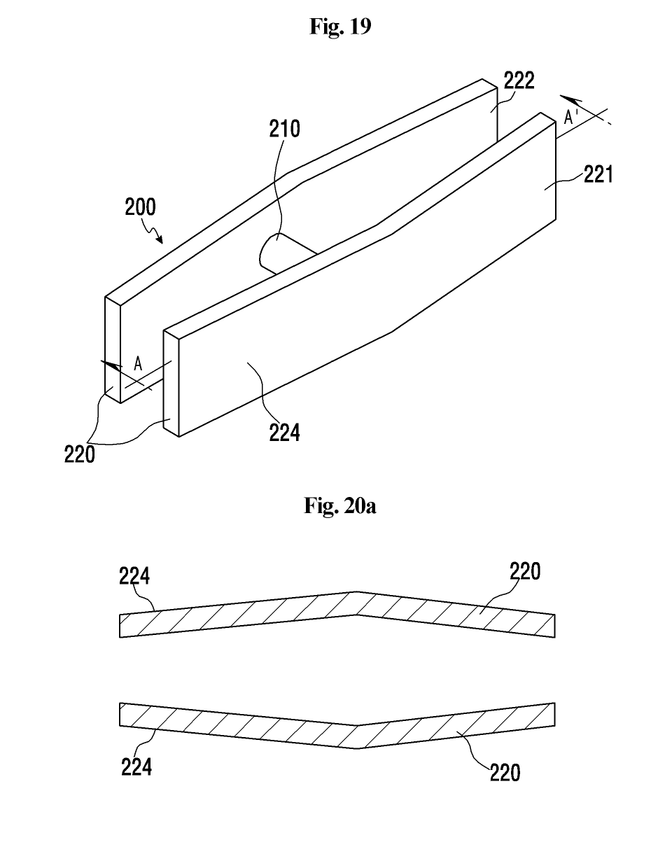

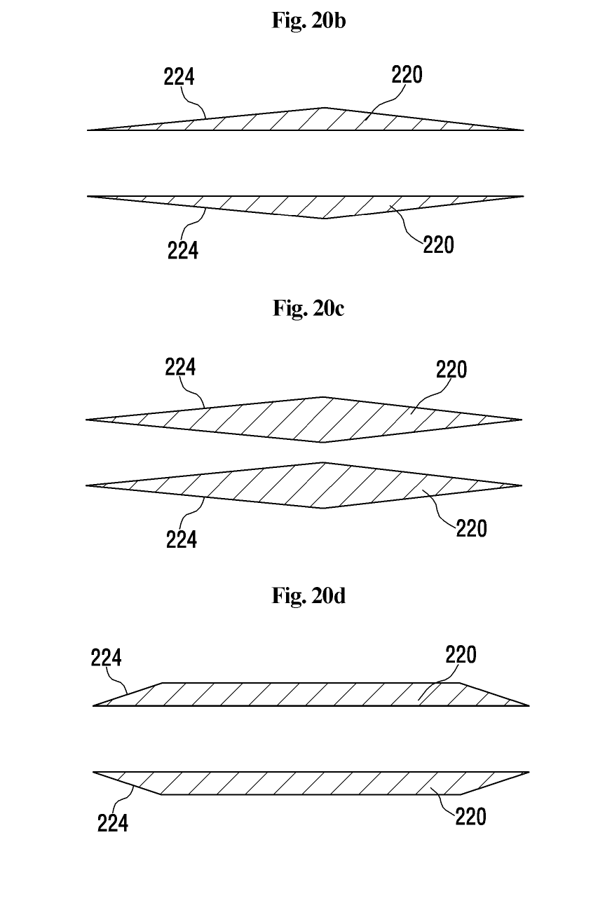

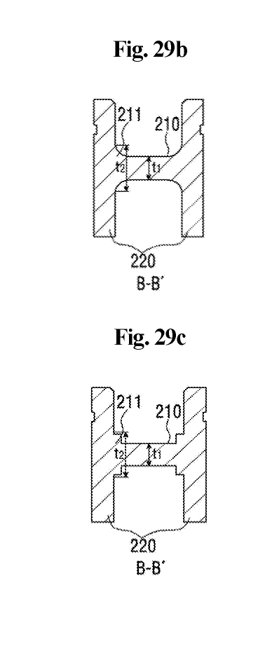

FIGS. 19 and 22 to 28 are perspective views showing the connection clip according to the third embodiment of the present invention. FIGS. 20a and 20d are cross sectional views of the connection clip according to the third embodiment of the present invention, which are taken along line A-A′ and are perpendicular to the height direction of the wiper blade. FIGS. 29a to 29c are cross sectional views of the connection clip according to the third embodiment of the present invention, which are taken along line B-B′ and are perpendicular to the longitudinal direction of the wiper blade.

As whit the connection clip 100 according to the first embodiment, the connection clip 200 according to the third embodiment may be made of a resin material and may be coupled to the cover 10 through the insert injection process. Hereinafter, the following description will focus on differences from the first embodiment.

The connection clip 200 may include a connection shaft 210 and a pair of supports 220 which are formed on both ends of the connection shaft 210 and face each other.

Referring to FIGS. 19 and 22 to 28, the support 220 may include a tapered portion 224 formed on the outside of the support 220 in the longitudinal direction of the wiper blade 1.

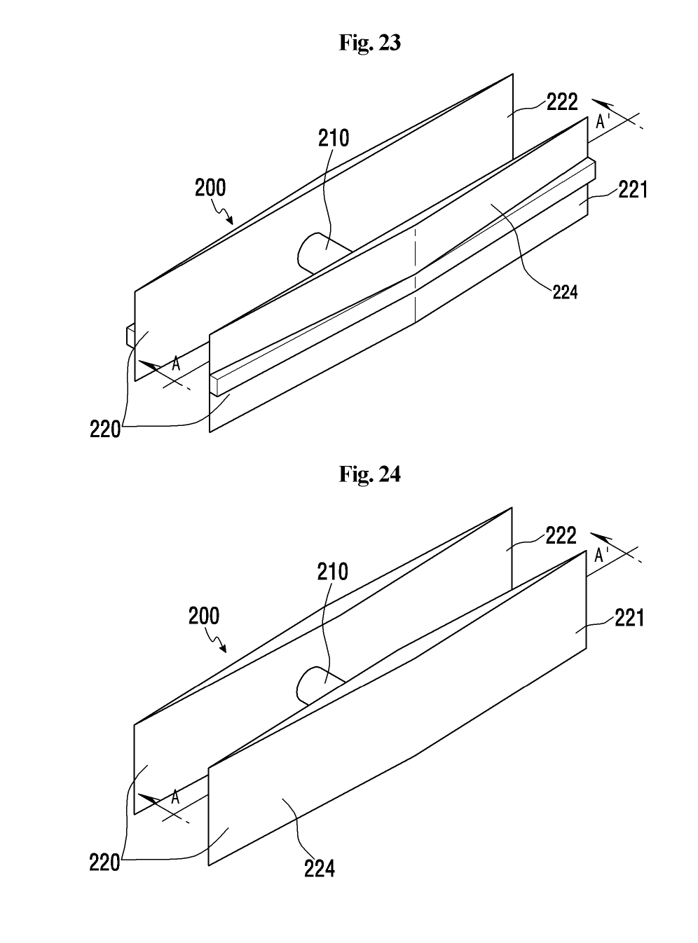

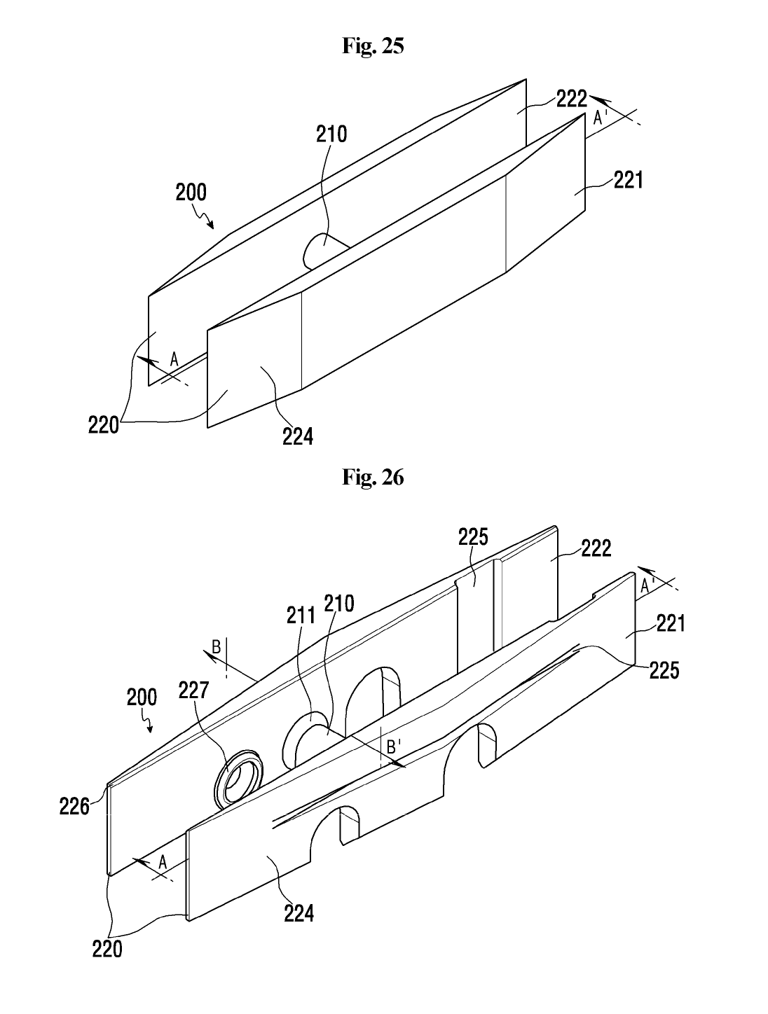

Specifically, referring to FIGS. 19 and 22 to 24, the support 220 may include the tapered portion 224 formed entirely from the center of the support 220 to the right end or left end of the support 220 in the longitudinal direction of the wiper blade 1. Also, as shown in FIG. 25, the support 220 may include the tapered portion 224 formed only on the right end or left end of the support 220. Also, as shown in FIGS. 19, 22 and 24 to 25, the support 220 may include the tapered portion 224 formed entirely from the bottom to the top of the support in the height direction of the wiper blade 1. Also, as shown in FIG. 23, the support 220 may include the tapered portion 224 formed only in the upper portion or the lower portion of the support.

FIG. 20a is a cross sectional view of the connection clip shown in FIG. 19 according to the third embodiment of the present invention, which is taken along line A-A′ and is perpendicular to the height direction of the wiper blade. FIG. 20b is a cross sectional view of the connection clip shown in FIGS. 22, 23 and 26 to 28 according to the third embodiment of the present invention, which is taken along line A-A′ and is perpendicular to the height direction of the wiper blade. FIG. 20c is a cross sectional view of the connection clip shown in FIG. 24 according to the third embodiment of the present invention, which is taken along line A-A′ and is perpendicular to the height direction of the wiper blade. FIG. 20d is a cross sectional view of the connection clip shown in FIG. 25 according to the third embodiment of the present invention, which is taken along line A-A′ and is perpendicular to the height direction of the wiper blade.

The width of the cross section of the tapered portion 224 of the support 220, which is perpendicular to the height direction of the wiper blade 1, may become smaller the farther it is from the connection shaft 210 in the longitudinal direction of the wiper blade 1. Specifically, as shown in FIGS. 20b to 20d, the width of the cross section of the tapered portion 224, which is perpendicular to the height direction of the wiper blade 1, may become smaller the farther it is from the connection shaft 210 in the longitudinal direction of the wiper blade 1.

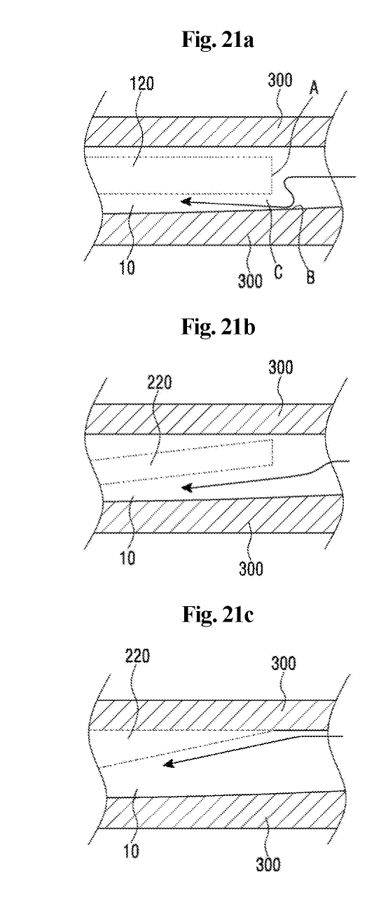

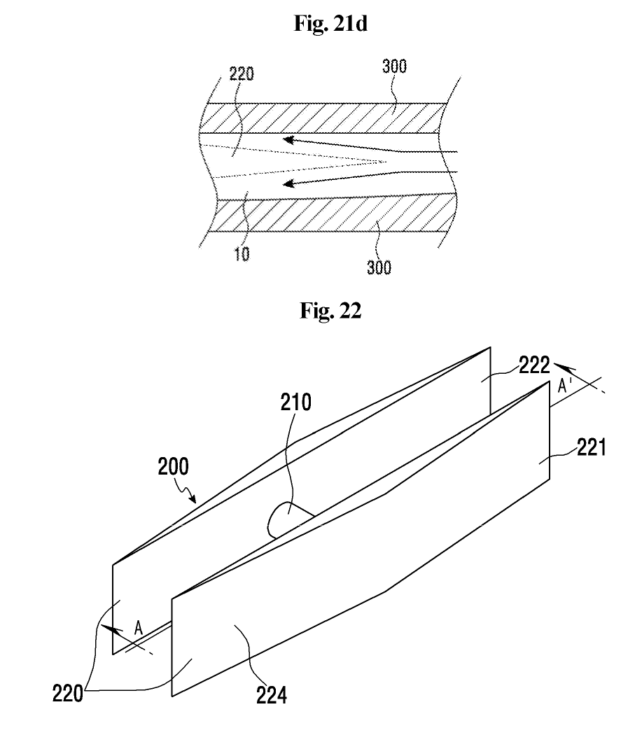

FIGS. 21a to 21d are views showing the flow of the resin material when the molten resin material is inserted into a mold in a state where the support of the connection clip according to the embodiment of the present invention is disposed within the mold for manufacturing the cover.

In the insert injection process, regarding the connection clip 100 according to the first embodiment, in a state where the support 120 of the connection clip 100 is, as shown in FIG. 21a, disposed within a mold 300 for manufacturing the cover 10, when the molten resin material, i.e., the material of the cover 10, is inserted into the mold, the resin material does not flow smoothly because the end surface “A” of the support 120 is perpendicular to the flow direction of the molten resin material inserted from a gate and an angle between the outer surface 121 of the support 120 and the end surface “A” of the support 120 is not greater than 90° . Specifically, the resin material inserted into the gate flows and collides with the end surface “A” of the support 120, and thus, the flow direction of the resin material is rapidly changed. Then, the resin material collides with the inner surface “B” of the mold and then the flow direction of the resin material is rapidly changed. Here, a pressure which is applied from the resin material to a portion “C” where the end surface “A” of the support 120 contacts the outer surface 121 of the support 120 becomes less than a pressure which is applied from the resin material to portions other than the portion “C”. After the resin material is inserted, the resin material is cooled for a short time. Therefore, the cover 10 may be formed in a state where the portion “C” where the end surface “A” of the support 120 contacts the outer surface 121 of the support 120 includes bubbles or in a state where a density of an injection molded product of the portion “C” where the end surface “A” of the support 120 contacts the outer surface 121 of the support 120 is less than that of the injection molded product of a portion other than the portion “C”. In this case, due to the bubbles, the external appearance of the cover 10 becomes poor and the coupling force between the connection clip 100 and the cover 10 is reduced.

On the contrary to this, regarding the connection clip 200 according to the third embodiment, in a state where the support 220 of the connection clip 200 is, as shown in FIGS. 21b and 21d, disposed within the mold 300 for manufacturing the cover 10, when the molten resin material, i.e., the material of the cover 10, is inserted into the mold, the resin material flows smoothly due to the tapered portion 224 formed on the outside of the support 220. Specifically, since the flow direction of the resin material inserted into the gate 310 is not rapidly changed while flowing along the outer surface of the tapered portion 224, a pressure which is applied from the resin material to a portion where the cover 10 contacts the support 220 is overall maintained relatively uniform. Therefore, even when the resin material is cooled for a short time after the resin material is inserted, bubbles are not formed in the portion where the cover 10 contacts the support 220, and the cover 10 may be formed in a state where an injection molded product of the portion where the cover 10 contacts the support 220 has a relatively uniform density. As a result, it is possible to manufacture the wiper blade 1 such that the cover 10 has a good external appearance and the coupling force between the connection clip 100 and the cover 10 is increased.

Referring to FIGS. 16 to 18 and 26 to 28, at least one groove 225 may be formed in the inner surface 222 or the outer surface 221 of the support 220. The groove 225 may be formed in the longitudinal direction of the wiper blade 1. When the groove 225 is in the longitudinal direction of the wiper blade 1, the molten resin material, i.e., the material of the cover 10 is introduced into and coupled to the groove 225 during the insert injection. Therefore, a coupling force between the connection clip 200 and the cover 10 in the height direction of the wiper blade 1 can be increased. Also, the groove 225 may be formed in the height direction of the wiper blade 1. When the groove 225 may be formed in the height direction of the wiper blade 1, the molten resin material, i.e., the material of the cover 10 is introduced into and coupled to the groove 225 during the insert injection. Therefore, a coupling force between the connection clip 200 and the cover 10 in the longitudinal direction of the wiper blade 1 can be increased. Although it has been described above that the groove 225 is formed in the inner surface 222 or the outer surface 221 of the support 220 of the connection clip 200 in the longitudinal direction or height direction of the wiper blade 1, a protrusion may be formed in the longitudinal direction or height direction of the wiper blade 1.

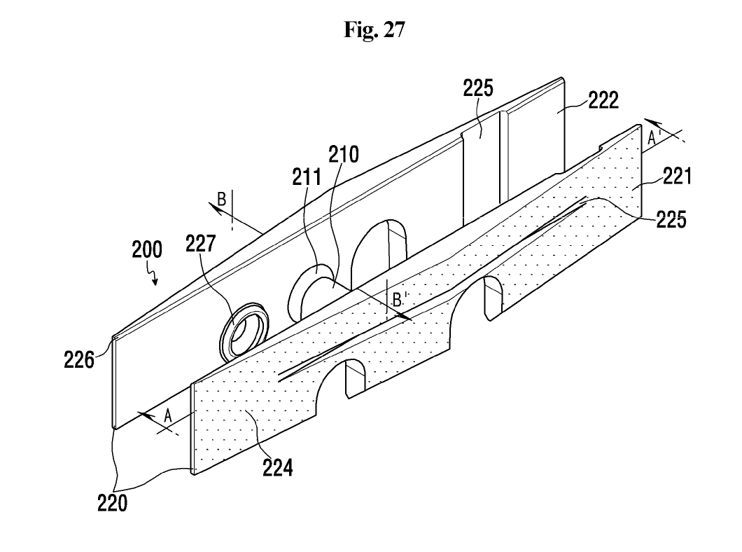

Referring to FIGS. 17 and 27, the inner surface 222 or the outer surface 221 of the support 220 may be rough. When the inner surface 222 or the outer surface 221 of the support 220 of the connection clip 200 is rough, the overall coupling force between the connection clip 200 and the cover 10 is increased. In the manufacture of the mold for manufacturing the connection clip 200, the surface of the mold can be roughed by electric discharge machining. Also, in a chemical machining of the mold after the electric discharge machining, the surface of the mold can be roughed by adjusting chemical machining specifications. Also, the surface of the mold can be roughed by omitting a polishing process on the surface of the mold after the electric discharge machining and the chemical machining are performed. As such, when the connection clip 200 is manufactured by using the mold having the rough surface, the inner surface 222 or the outer surface 221 of the support 220 of the connection clip 200 can be roughed.

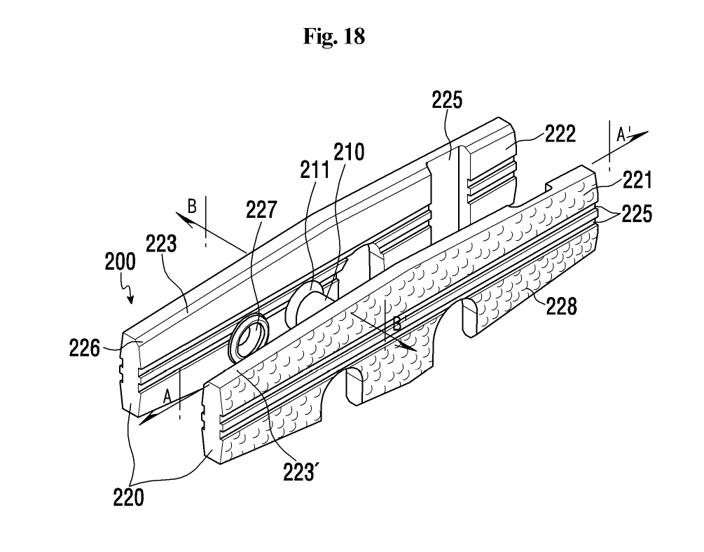

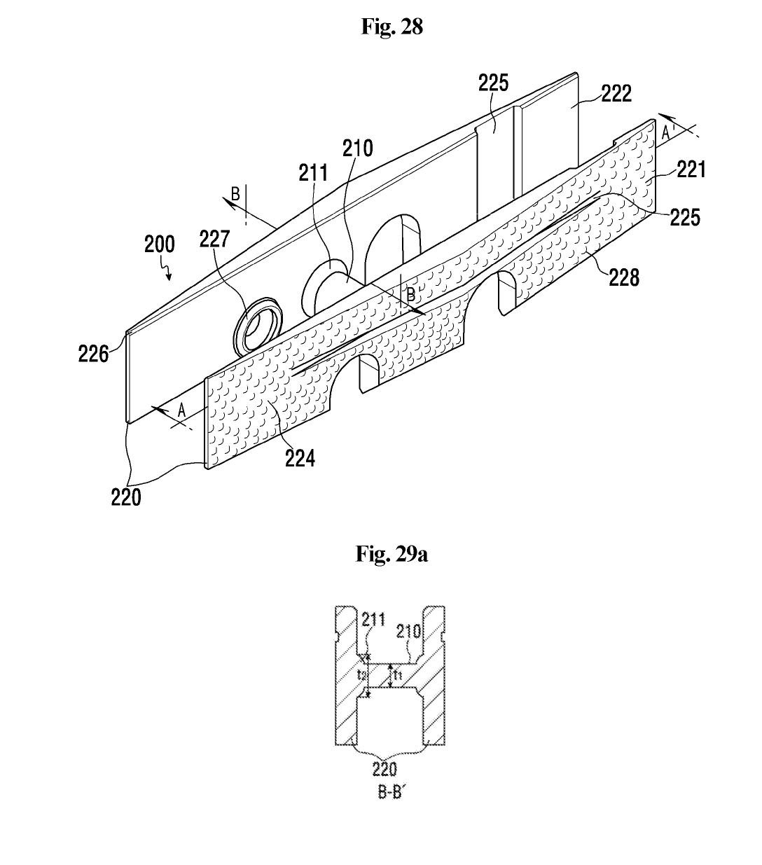

Referring to FIGS. 18 and 28, a plurality of protrusions 228 may be formed on the inner surface 222 or the outer surface 221 of the support 220. When the plurality of protrusions 228 are formed, the molten resin material is introduced between and coupled to the protrusions during the insert injection. Therefore, the overall coupling force between the connection clip 200 and the cover 10 is increased.

Referring to FIGS. 16 to 18 and 26 to 28, a chamber 226 may be formed on the top or the bottom of the inner surface 222 of the support 220. In the disposition of the pre-manufactured connection clip 200 within the mold for manufacturing the cover 10, the connection clip 200 should be inserted into a very small space between the molds. Even when the connection clip 200 is not inserted into a correct position within the mold and the upper portion or lower portion of the support 220 of the connection clip 200 contacts the mold, the connection clip 200 is able to move to the correct position while the mold contacts along the inclined surface of the chamber 226. Therefore, a worker can easily work.

Referring to FIGS. 16 to 18 and 26 to 28, an arm fixing recess 227 to which an end of a pin-type arm is fixed may be formed in the inner surface 222 of the support 220 of the connection clip 200. In order that the arm fixing recess 227 to which an end of a pin-type arm is fixed is formed in the inner surface of the side wall 11 of the cover 10, it is easier to add a shape for forming the arm fixing recess 227 to the mold for manufacturing the cover 10 that to add a shape for forming the arm fixing recess 227 to the mold for manufacturing the connection clip 200. Also, the arm fixing recess 227 is formed in the connection clip 200 which have the precisely managed distance between the inner surfaces of the pair of supports 120, so that it is easy to manage a dimension of an arm fixing portion.

Referring to FIGS. 16 to 18 and 26 to 28, a thickened portion 211 may be formed on the connection shaft 210 of the connection clip 200. Specifically, the thickened portion 211 may be formed on a portion where the connection shaft 210 contacts the support 220. When torsion occurs in the width direction of the wiper blade 1, stress is concentrated on the portion where the connection shaft 210 contacts the support 220. Therefore, an effect that the portion where the connection shaft 210 contacts the support 220 is prevented from being damaged is more improved with the increase of the thickness of the portion where the connection shaft 210 contacts the support 220. Specifically, as shown in FIGS. 9e to 9g and 29a to 29c, the thickened portion 211 may be formed such that the thickness t2 of the portion where the connection shaft 210 contacts the support 220 is larger than the thickness t1 of the connection shaft 210. As shown in FIGS. 9e and 29a, the thickened portion 211 may have a round shape which is convex outwardly, or as shown in FIGS. 9f and 29b, the thickened portion 211 may have a round shape which is concave inwardly. Also, as shown in FIGS. 9g and 29c, the thickened portion 211 may have a cylindrical shape thicker than the connection shaft 210. Also, in order that the connection clip 200 is arranged at a correct position within the mold during the insert injection, a portion is required where the connection clip 200 contacts and is coupled to the mold. Here, when the mold contacts an outer surface 212 of the thickened portion 211, the movements of the connection clip in the height direction and longitudinal direction of the wiper blade 1 is restricted by the mold, so that the connection clip 200 is easily arranged at a correct position within the mold.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

What is claimed is:

1. A wiper blade comprising:
a wiper strip which wipes a window glass of a vehicle;
a lever assembly which supports the wiper strip; and
a cover which is coupled to a wiper arm and receives the lever assembly,
wherein the cover comprises a connection clip which is made of a resin material and is coupled to the cover by using an insert injection process,
wherein the connection clip comprises a connection shaft and a pair of supports which are formed on both ends of the connection shaft and face each other,
wherein the support comprises a wide width portion and a narrow width portion in a cross section of the support, which is perpendicular to a longitudinal direction of the wiper blade,
and wherein a width of the narrow width portion in a width direction of the wiper blade is less than a width of the wide width portion in the width direction of the wiper blade.

2. The wiper blade of claim 1, wherein a width of the narrow width portion becomes smaller toward an upper end or a lower end of the support from the connection shaft.

3. The wiper blade of claim 1, wherein a flexural rigidity of the connection clip is higher than a flexural rigidity of the cover.

4. The wiper blade of claim 1, wherein the connection clip is melted-bonded to the cover.

5. The wiper blade of claim 1, wherein a length of the support in the longitudinal direction of the wiper blade is greater than a height of the support in a height direction of the wiper blade.

6. The wiper blade of claim 1, wherein the cover comprises a pair of side walls facing each other and wherein the supports are fully inserted into the side walls respectively.

7. The wiper blade of claim 1, wherein the cover comprises a pair of side walls facing each other, and a recess formed between the pair of side walls, and the support is inserted into the side wall such that at least a portion of an inner surface of the support is exposed to the recess.

8. A wiper blade comprising:
a wiper strip which wipes a window glass of a vehicle;
a lever assembly which supports the wiper strip; and
a cover which is coupled to a wiper arm and receives the lever assembly,
wherein the cover comprises a connection clip which is made of a resin material and is coupled to the cover by using an insert injection process,
wherein the connection clip comprises a connection shaft and a pair of supports which are formed on both ends of the connection shaft and face each other,
wherein the support comprises a wide width portion and a narrow width portion in a cross section of the support, which is perpendicular to a width direction of the wiper blade,
and wherein a width of the narrow width portion in a height direction of the wiper blade is less than a width of the wide width portion in the height direction of the wiper blade.

9. The wiper blade of claim 8, wherein a groove or a protrusion is formed in an inner surface or an outer surface of the support in a longitudinal direction or the height direction of the wiper blade.

10. The wiper blade of claim 8, wherein a plurality of protrusions are formed on at least one of an inner surface and an outer surface of the support.

11. The wiper blade of claim 8, wherein an inner surface or an outer surface of the support is rough.

12. The wiper blade of claim 8, wherein a chamber is formed on a top or a bottom of an inner surface of the support.

13. The wiper blade of claim 8, wherein an arm fixing recess to which an end of a pin-type arm is fixed is formed in the inner surface of the support.

14. The wiper blade of claim 8, wherein a thickened portion is formed on a portion where the connection shaft contacts the support.

15. A wiper blade comprising:
a wiper strip which wipes a window glass of a vehicle;
a lever assembly which supports the wiper strip; and
a cover which is coupled to a wiper arm and receives the lever assembly,
wherein the cover comprises a connection clip which is made of a resin material and is coupled to the cover by using an insert injection process,
wherein the connection clip comprises a connection shaft and a pair of supports which are formed on both ends of the connection shaft and face each other,
and wherein the support comprises a tapered portion formed on the outside of the support in a longitudinal direction of the wiper blade.

16. The wiper blade of claim 15, wherein a width of a cross section of the tapered portion, which is perpendicular to a height direction of the wiper blade, becomes smaller toward a right end or a left end of the support from the connection shaft.

17. The wiper blade of claim 15, wherein a flexural rigidity of the connection clip is higher than a flexural rigidity of the cover, and wherein the connection clip is melted-bonded to the cover.

18. The wiper blade of claim 15, wherein a length of the support in the longitudinal direction of the wiper blade is greater than a height of the support in a height direction of the wiper blade.

19. The wiper blade of claim 15, wherein the cover comprises a pair of side walls facing each other and wherein the supports are coupled to the side walls respectively in such a manner as to be fully inserted into the side wall.

20. The wiper blade of claim 15, wherein the cover comprises a pair of side walls facing each other, and a recess formed between the pair of side walls, and the support is inserted into the side wall such that at least a portion of an inner surface of the support is exposed to the recess.
